(19) United States
(12) Patent Application Publication
(10) Pub. No.: US 2017/0103739 A1
(43) Pub. Date: Apr. 13, 2017

(54) INSTRUMENT STAND

(71) Applicant: YACUI CHEN, SHENZHEN (CN)

(72) Inventor: ZHIHUI LIANG, LIANZHOU CITY (CN)

(21) Appl. No.: 15/062,314

(22) Filed: Mar. 7, 2016

(30) Foreign Application Priority Data
Oct. 13, 2015 (CN) 201520474879.3

(51) Int. Cl. G10G 5/00; F16M 11/16; F16M 11/22

(52) U.S. Cl. CPC G10G 5/00; F16M 11/22; F16M 11/16; F16M 2200/08

(57) ABSTRACT

The instrument stand provided by the instant disclosure includes a pair of bases, a pair of supporting portions arranged on the bases and a linking portion connecting the bases, the linking portion includes a pair of supporting stands and a connecting portion connecting the supporting stands. The bases pivotally connect to the supporting stands through a pair of first pivot portions, and the linking portion connects to the supporting stands through a second pivot portion. The instrument stand provided by the instant disclosure may be folded or rotate along a plurality directions and may deform through retracting. Accordingly, the instrument stand provided by the instant provides conveniency and may be adapted to various instruments

### BACKGROUND

1. Technical Field

The present disclosure relates to an instrument stand, in particular, to an instrument stand for placing instruments such as guitar, ukulele and violin.

2. Description of Related Art

While not in use, instruments such as guitar, ukulele and violin should be placed on stands that enable the instrument to be put or taken easily. The stands also provide the function of protecting the instruments from damages. The existing stands are unable to be folded or retracted and hence, are not easy to carry and are not portable.

### SUMMARY

In order to solve the above problem, the instant disclosure provides a foldable and retractable instrument stand.

Specifically, the instrument stand of the instant disclosure includes a pair of bases, a pair of supporting portions arranged on the bases and a linking portion connecting the bases, the linking portion comprises a pair of supporting stands connected to the pair of bases respectively and a connecting portion connecting the supporting stands, the bases pivotally connect to the supporting stands through a pair of first pivot portions, and the connecting portion pivotally connects to the supporting stands through a second pivot portion.

Furthermore, each first pivot portion has a first pivot axis and the second pivot portion has a second pivot axis, and the first pivot axis is vertical to the second pivot axis.

Furthermore, each base comprises a connecting rod and two foots arranged on the two ends of the connecting rod.

Furthermore, the connecting rod has a sleeve surroundingly arranged thereon, and the connecting rod is able to retract inwardly relative to the sleeve.

Furthermore, the supporting portions may slide relative to the bases.

The instrument stand provided by the instant disclosure is able to rotate and be folded along a plurality of directions, and may deform through retracting. Accordingly, the instrument stand provided by the instant provides conveniency and may be adapted to various instruments.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is a three-dimensional view of an instrument stand of an embodiment of the instant disclosure in an unfolding state.

FIG. 2 is a three-dimensional view of the instrument stand of the embodiment of the instant disclosure in a partial retracting state.

FIG. 3 is a three-dimensional view of the instrument stand of the embodiment of the instant disclosure in a partial retracting state.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

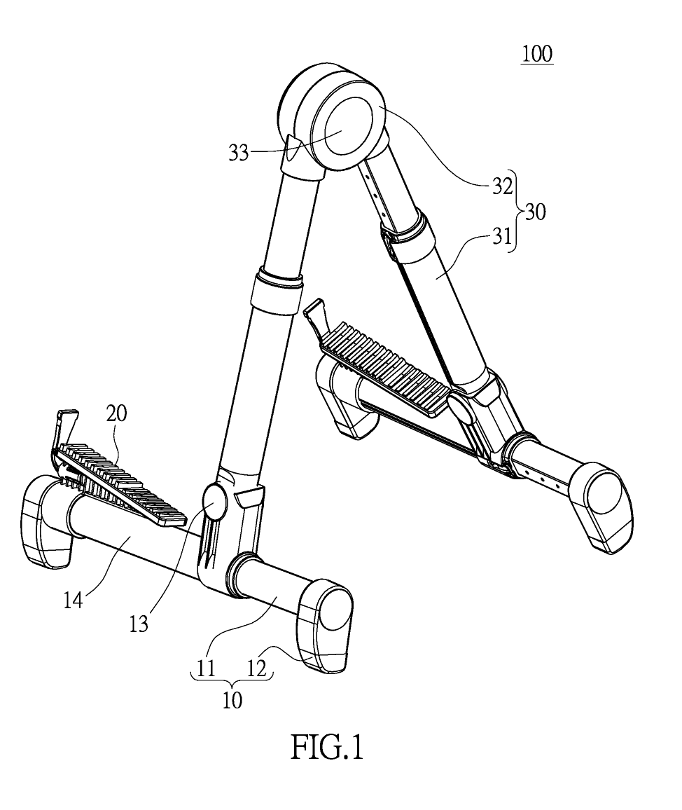

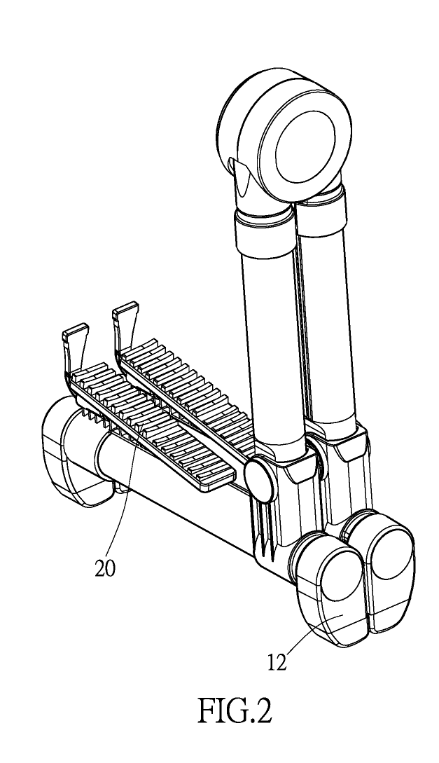

Please refer to FIG. 1. The instrument stand 100 provided by the instant disclosure is for installing and securing an instrument thereon. The instrument stand 100 comprises a pair of bases 10, a pair of supporting portions 20 arranged on the bases 10 and a linking portion 30 connecting the bases 10. The supporting portions 20 are for supporting and securing the instrument. Each base 10 comprises a connecting rod 11 and two foots 12 fixedly arranged on the two ends of the connecting rod 11. The supporting portions 20 are arranged on the connecting rods 11 and may slide relative to the connecting rods 11 respectively, thereby adapting to different instruments with different sizes. Each connecting rod 11 has a sleeve 14 surroundingly arranged thereon, and each connecting rod 11 may retract inwardly relative to the sleeve 14 to realize the inwardly retraction of the instrument stand 100. The retraction state of the instrument stand 100 is shown in FIG. 2. Each foot 12 has a silicone protecting sleeve 121 surroundingly positioned thereon for preventing the foot 12 from wear and tear and providing slip-proof effect.

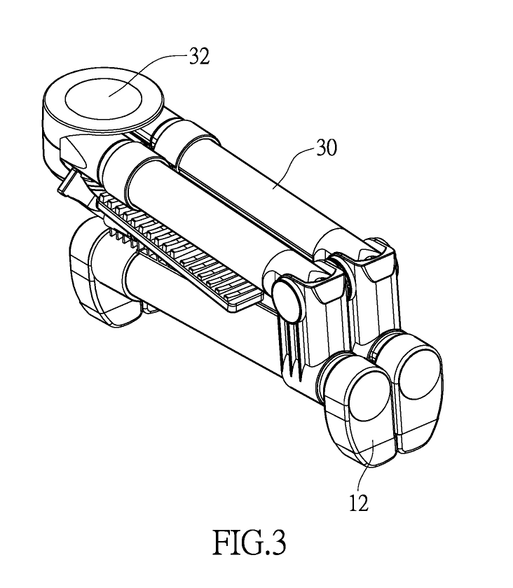

The linking portion 30 comprises a pair of supporting stands 31 connected to the pair of bases 10 respectively and a connecting portion 32 connecting the two supporting stands 31. The structure of each supporting stand 31 is the same as that of the connecting rod 11 and the sleeve 14, i.e., one end of each supporting stand 31 may retract inwardly. The connecting portion 32 is a cylinder. The connecting portion 32 pivotally connects the supporting stands 31 through a second pivot portion 33, and hence, the supporting stands 31 may rotate relative to the connecting portion 32. Accordingly, the instrument stand 100 is easy to be fold or carried as shown in FIG. 2. The bases 10 pivotally connect to the supporting stands 31 through a pair of first pivot portions 13, thereby enabling the supporting stands 31 to rotate relative to the bases 10. FIG. 3 shows the fully retraction state of the instrument stand 100. Comparing with the extended state, the fully retraction state saves large space and the instrument stand 100 becomes portable. By increasing the damping during the rotation of the supporting stands 31, it would be able to avoid the rotation of the supporting stands 31 while supporting an instrument. In a preferred embodiment, each first pivot portion has a first pivot axis and the second pivot portion has a second pivot axis, and the first pivot axis is vertical to the second pivot axis.

A surface of each supporting portion 20 has a plurality of supporting ribs 21 discretely positioned thereon, and an end of each supporting portion 20 has a blocking portion 22 projectedly positioned thereon. The supporting ribs may increase the friction between the supporting portions 20 and the instrument to prevent the displacement of the instrument, and the blocking portion 22 may prevent the instrument from fallout from the instrument stand 100. In another embodiment, the plurality of supporting ribs 21 are replaced by beads.

In summary, the instant disclosure provides an instrument stand 100 that is easy to fold and retract. Furthermore, the connecting rods 11 in may retract inwardly relative to the sleeves 14 in the horizontal direction for adjusting the length of the instrument stand 100 in the horizontal direction, thereby ensuring the steadiness of the instrument stand 100 and enabling the instrument stand 100 to adapt different instruments. In addition, the supporting stands 31 may be retracted or extended in the vertical direction, thereby adjusting the height of the instrument stand 100. The two supporting stands 31 may rotate relative to the linkage portion 32 and the first pivot portions 13, thereby folding the instrument stand 100 along two dimensions. Accordingly, the instrument stand 100 may be retracted into a compact structure as shown in FIG. 3.

The above-mentioned descriptions represent merely the exemplary embodiment of the instant disclosure, without any intention to limit the scope of the present disclosure thereto. Various equivalent changes, alternations or modifications based on the claims of the instant disclosure are all consequently viewed as being embraced by the scope of the present disclosure.

What is claimed is:

1. An instrument stand, comprising:
a pair of bases;
a pair of supporting portions arranged on the bases; and
a linking portion connecting the bases;
wherein the linking portion comprises a pair of supporting stands connected to the bases respectively and a connecting portion connecting the supporting stands;
wherein the bases connect to the supporting stands through a pair of first pivot portions, and the connecting portion connects to the supporting stands through a second pivot portion.

2. The instrument stand according to claim 1, wherein each first pivot portion has a first pivoting axis and the second pivot portion has a second pivoting axis, and the first pivoting axis is vertical to the second pivoting axis.

3. The instrument stand according to claim 2, wherein each base comprises a connecting rod and two foots arranged on two ends of the connecting rod, and the connecting rod pivotally connects to an end of one of the supporting stands.

4. The instrument stand according to claim 3, wherein each foot has a silicone protecting sleeve surroundingly positioned thereon.

5. The instrument stand according to claim 3, wherein each connecting rod has a sleeve surroundingly positioned thereon and the connecting rod retracts inwardly relative to the sleeve.

6. The instrument stand according to claim 2, wherein the supporting portions slide relative to the bases.

7. The instrument stand according to claim 1, wherein each supporting portion has a plurality of supporting ribs discretely positioned thereon, and an end of each supporting portion has a blocking portion projectedly positioned thereon.

8. The instrument stand according to claim 2, wherein the supporting stands move upward and downward relative to the first pivot portions.
